(19) United States
(12) Patent Application Publication
(10) Pub. No.: US 2019/0113975 A1
(43) Pub. Date: Apr. 18, 2019

(54) REMOTE CONTROL ARENA

(71) Applicant: Tyler Christensen, Alpine, UT (US)

(72) Inventor: Tyler Christensen, Alpine, UT (US)

(21) Appl. No.: 15/786,376

(22) Filed: Oct. 17, 2017

(51) Int. Cl. G06F 3/01; A63H 30/04; G05D 1/00; G06T 19/00

(52) U.S. Cl. CPC G06F 3/016; A63H 30/04; G06F 2203/013; G06T 19/006; G05D 2201/0214; G05D 1/005

(57) ABSTRACT

Remote control arena and systems for enabling first-person view (FPV) within the remote control arena are provided. The remote control arena can be configured to allow a number of users to participate in various games using their remote control vehicles. The remote control arena can include a rounded interface between the floor and the walls to thereby allow the remote control vehicles to drive up the walls while participating in a game. The walls may be transparent to allow the users to view their vehicles from outside the arena. The remote control arena may include a number of cockpits in which the users may sit to control their vehicles using FPV techniques.

### CROSS-REFERENCE TO RELATED APPLICATIONS

N/A

### BRIEF SUMMARY

The present invention is generally directed to a remote control arena and to systems for enabling first-person view (FPV) within the remote control arena. The remote control arena can be configured to allow a number of users to participate in various games using their remote control vehicles. The remote control arena can include a curved interface between the floor and the walls to thereby allow the remote control vehicles to drive up the walls while participating in a game. The walls may be transparent to allow the users to view their vehicles from outside the arena. The remote control arena may include a number of cockpits in which the users may sit to control their vehicles using FPV techniques.

In one embodiment, the present invention is implemented as a remote control arena that includes walls defining an enclosed area. At least some of the walls are formed by vertical posts that are interconnected by horizontal supports, curved supports that extend inwardly from each vertical post, vertical walls that are coupled to the vertical posts to form a continuous vertical surface, and curved walls positioned below the vertical walls. The curved walls extend overtop and conform to the curved supports to form a continuous curved interface between a floor of the arena and the vertical walls.

In another embodiment, the present invention is implemented as remote control arena that includes walls defining an enclosed area and a plurality of cockpits. At least some of the walls are formed by curved walls and vertical walls. The curved walls form a continuous curved interface between a floor of the arena and the vertical walls. Each of the cockpits includes a seat in which a user sits while driving a vehicle in the arena, a screen on which a video feed received from a camera mounted on the corresponding vehicle is displayed, and a head tracker for detecting a relative orientation of the user's head and for generating and sending control signals to control a relative orientation of the camera on the vehicle.

In another embodiment, the present invention is implemented as a remote control arena that includes: an enclosed area; vehicles that are configured to be controlled within the enclosed area, each vehicle including a camera that is mounted to enable the camera's orientation to be adjusted, a video transmitter for transmitting a video feed output from the camera, and a camera controller for controlling the camera's orientation; and a plurality of cockpits in which users sit while controlling the vehicles, each cockpit including a seat, a screen on which the video feed received from the camera mounted on the corresponding vehicle is displayed, and a head tracker for detecting a relative orientation of the user's head and for generating and sending control signals to the camera controller on the corresponding vehicle. The camera controller controls the camera's orientation in accordance with the control signals received from the head tracker in the corresponding cockpit such that the orientation of the camera relative to the vehicle corresponds to the orientation of the user's head relative to the corresponding cockpit.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 illustrates a remote control arena in accordance with one or more embodiments of the present invention;

FIG. 1A illustrates a cross-sectional view of the remote control arena of claim 1;

FIG. 2 illustrates the remote control arena of FIG. 1 with the addition of various cockpits;

FIG. 2A illustrates a cockpit;

FIG. 3 illustrates how a game can be played in the remote control arena of FIG. 1; and

FIG. 4 illustrates a system for enabling FPV within the remote control arena of FIG. 1.

### DETAILED DESCRIPTION

In this specification, the term “remote control vehicle” or simply “vehicle” should be construed as any type of vehicle that can be controlled by a user that is located remotely from the vehicle. For example, a remote control vehicle could be a car, a truck, a boat, an airplane, etc. As is known, such vehicles are controlled using wireless communications.

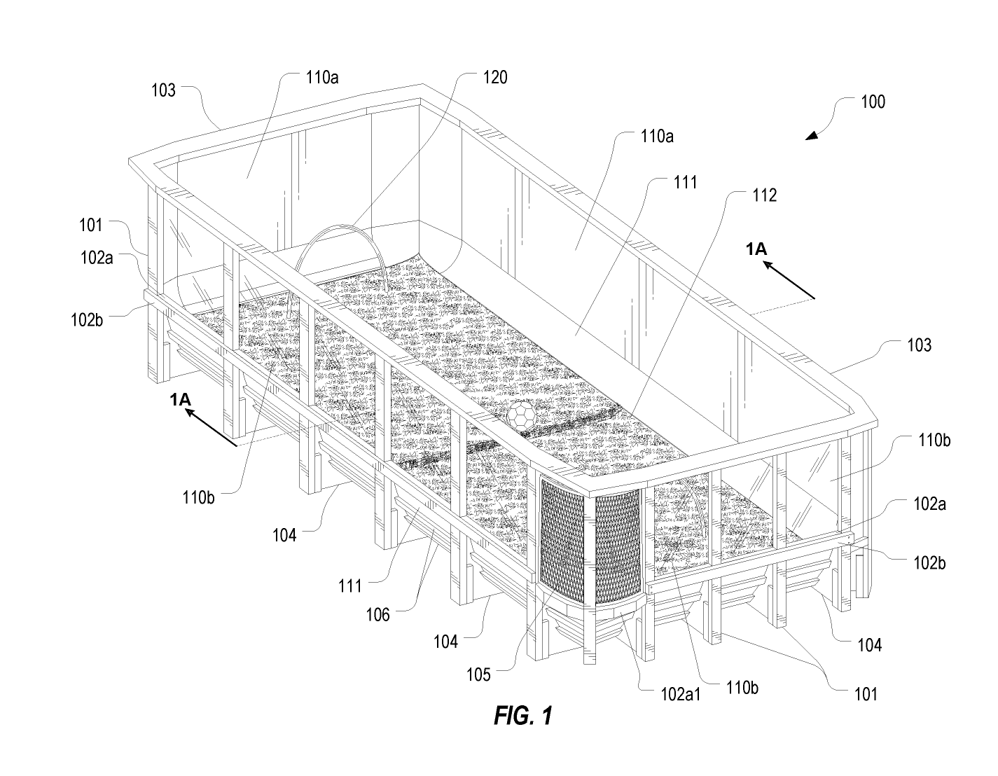

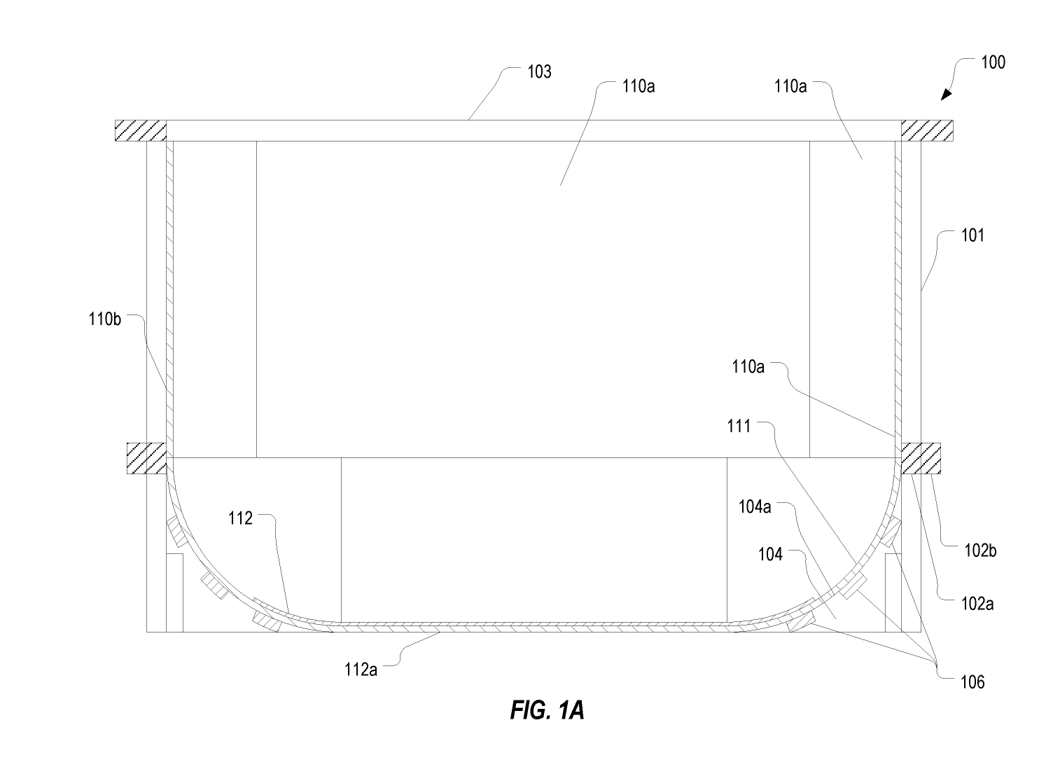

FIGS. 1 and 1A illustrate a perspective top view and a cross-sectional view respectively of a remote control arena 100 that is configured in accordance with one or more embodiments of the present invention. Arena 100 is formed as an enclosed area within which remote control vehicles may be operated to participate in a game or other activity. Although arena 100 is shown as having a rectangular shape, it may equally be configured in an oval, circular, square or other shape.

The area of arena 100 is defined by outer walls formed by vertical posts 101 that are interconnected by various types of horizontal supports 102a, 102b, 103. Inner horizontal supports 102a extend between each adjacent pair of vertical posts 101 and couple to an inner side of the adjacent pair of vertical posts 101. In conjunction with vertical posts 101, inner horizontal posts 102a define a plane of the walls. In contrast, outer horizontal support 102b are positioned overtop inner horizontal supports 102a and each outer horizontal support 102b couples to an exterior side of two or more vertical posts 101. Upper horizontal posts 103 also extend between two or more vertical posts 101 but are positioned above and couple to a top end of vertical posts 101. In some embodiments, vertical posts 101 may alternatively extend upwardly to and couple with the ceiling such that upper horizontal supports 103 may be omitted.

A curved support 104 is coupled to and extends inwardly from each vertical post 101. As is best seen in FIG. 1A, curved support 104 includes an outer side that aligns with vertical post 101 and an inner side 104a that is curved. In the depicted embodiment, inner side 104a forms a quarter circle having a radius of around two feet, but a larger or smaller radius could also be used. Inner side 104a could also be configured with an elliptical shape rather than a circular shape.

In some embodiments, such as is represented in FIG. 1A, arena 100 may include a subfloor 112a that extends between the inner edges of curved supports 104 (or possibly overlaps the inner edges of curved supports 104). However, in some embodiments, such as when arena 100 is located in a building having a relatively smooth floor, subfloor 112a can be omitted.

Whether or not arena 100 includes subfloor 112a, the walls of arena 100 can be formed of vertical walls 110a, 110b (or collectively 110) and curved walls 111. Curved walls 111 can be formed of any material that is sufficiently flexible to conform to the curvature of inner side 104a of curved support 104. For example, curved walls 111 can be formed of a bendable wood or composite material. Each section of curved wall 111 can extend between two or more curved supports 104 to form a continuous curved interface between the floor and vertical walls 110 of arena 100.

Vertical walls 110 can be positioned above curved walls 111 to form a continuous vertical surface along vertical posts 101. Vertical walls 100 can be either transparent vertical walls 110a or opaque vertical walls 110b. Transparent vertical walls 110a, as opposed to opaque vertical walls 110b, can be employed on sides or portions of arena 100 where users and/or spectators may be located to thereby allow them to see into arena 100. In some embodiments, arena 100 may include only opaque vertical walls 110b as will be described below. In the depicted embodiment, arena 100 includes transparent vertical walls 110a along two adjoining sides and opaque vertical walls 110b along the opposing two adjoining sides. Although not shown, in some embodiments, spectators and/or users could be positioned above vertical walls 110 such that they may look over vertical walls 110 and into arena 100. In such embodiments, only opaque vertical walls 110b may be employed.

As is best seen in FIG. 1A, the transition from curved wall 111 to vertical wall 110 can be positioned overtop inner horizontal supports 102a. In this way, inner horizontal supports 102a will reinforce the edges of curved walls 111 and vertical walls 110. Also, although curved support 104 will provide the majority of the support to curved walls 111, arena 100 may also include a number of reinforcing supports 106 that span between adjacent pairs of curved supports 104. As shown in FIG. 1A, a number of reinforcing supports 106 (e.g., three) can be spaced along curved inner side 104a to prevent curved walls 111 from sagging when a vehicle (or other item or individual) is positioned on the curved walls.

Curved walls 111 form a curved interface that enables vehicles to drive up the walls of arena 100. Accordingly, the radius of curvature can be selected to be appropriate for the smaller size of remote control vehicles. Also, in some embodiments, arena 100 may include curved walls 111 only on some of its sides depending on the intended use of the arena. For example, arena 100 could be configured with curved walls 111 only along its longer sides but not along its shorter sides. In such cases, on sides without curved walls 111, vertical walls 110 can extend the full length of vertical posts 101. Although not shown, in some embodiments, vertical walls 110 may extend up to a ceiling and curved walls 111 can be formed between vertical walls 110 and the ceiling in a similar manner as they are formed between vertical walls 110 and the floor (e.g., using curved supports 104 to support curved walls 111). In such embodiments, vehicles will be enabled to drive up vertical walls 110 and onto the ceiling due to the curved interface formed at the top and the bottom of arena 100.

To facilitate entry, arena 100 can include a gate 105. In the depicted embodiment, gate 105 is formed in a corner of arena 100 in place of vertical wall 110. Gate 105 can preferably be formed of a rigid material that is coupled on one side to a vertical post 101 via hinges or another pivoting mechanism to thereby allow gate 105 to swing open and closed. As shown, gate 105 can be formed of a mesh material to thereby provide rigidity without preventing users from seeing through the gate into arena 100. A gate opening can be defined by a horizontal support 102a1 that, in some embodiments, can be positioned below inner horizontal supports 102a to facilitate stepping into arena 100.

Arena 100 may also include a surface 112 that is placed on the ground (or on subfloor 112a) and spans between opposing walls. In the depicted embodiment, surface 112 is an artificial turf to cause arena 100 to resemble a soccer field. In other embodiments, surface 112 could be carpet, wood, plastic, ice, water, etc. Arena 100 may also include various types of game equipment. For example, in FIG. 1, arena 100 includes soccer goals 120 that are built into and supported by surface 112 and/or subfloor 112a.

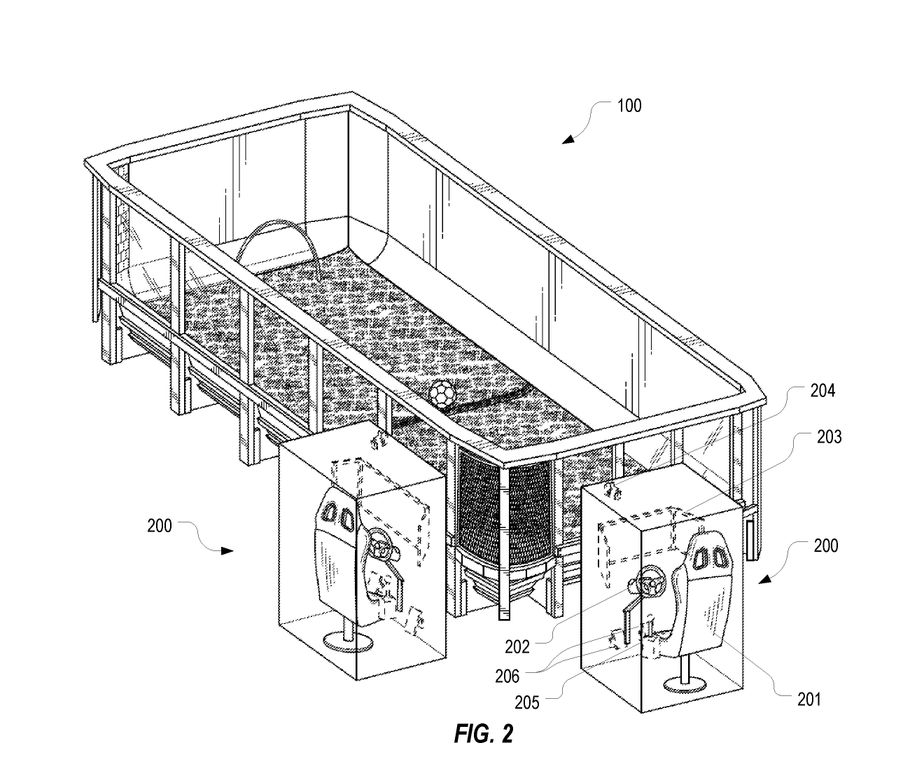

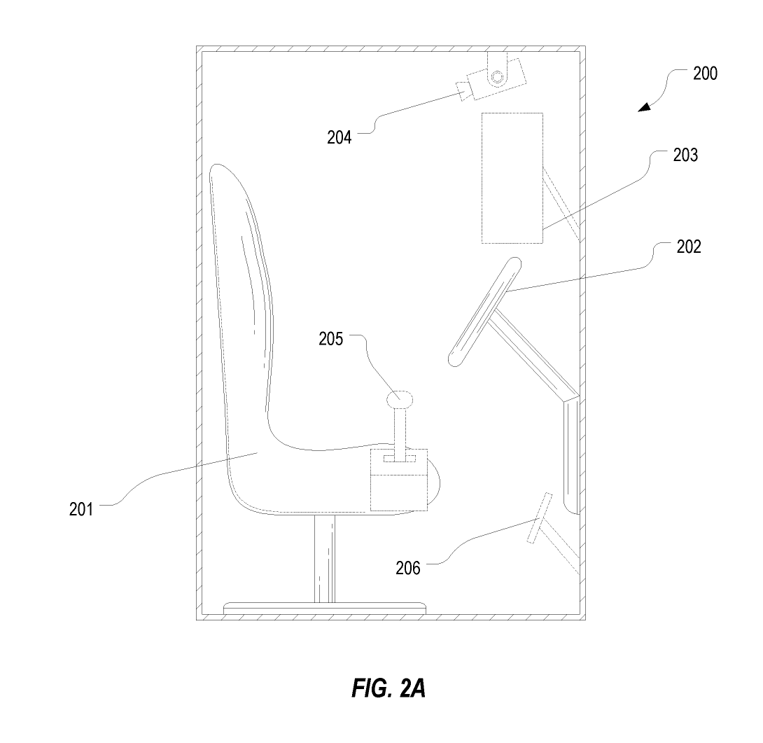

In some embodiments, such as is represented in FIG. 2, arena 100 may include a number of cockpits 200. Cockpits 200 are intended to resemble the cockpit of a race car and can be used to provide a first-person view experience within arena 100. Although two cockpits 200 are shown, arena 100 may include any reasonable number of cockpits. Also, in embodiments where cockpits 200 are provided, arena 100 may only include opaque vertical walls 100b since there would be no need for the users to see into arena 100. However, arena 100 may still include transparent vertical walls 100a to allow spectators to view into arena 100.

Each cockpit 200 can include a number of components such as a seat 201, a steering wheel 202 for steering a vehicle, a screen (or display) 203 on which a first-person view can be provided, a head tracking device 204 to track movement of the user's head while controlling a vehicle, and other vehicle controls such as a stick shift 205 (e.g., for forward and reverse or possibly for shifting gears) and pedals 206 (e.g., brake and gas pedals). These controls can be selected based on the type of remote control vehicle. For example, a joystick may be provided when the vehicle is a remote control plane and a throttle may be provided when the vehicle is a remote control boat. In some embodiment, screen 203 and/or head tracking device 204 can be replaced by a virtual reality headset. Also, steering wheel 202, stick shift 205 and/or pedals 206 may be replaced by a traditional handheld remote control.

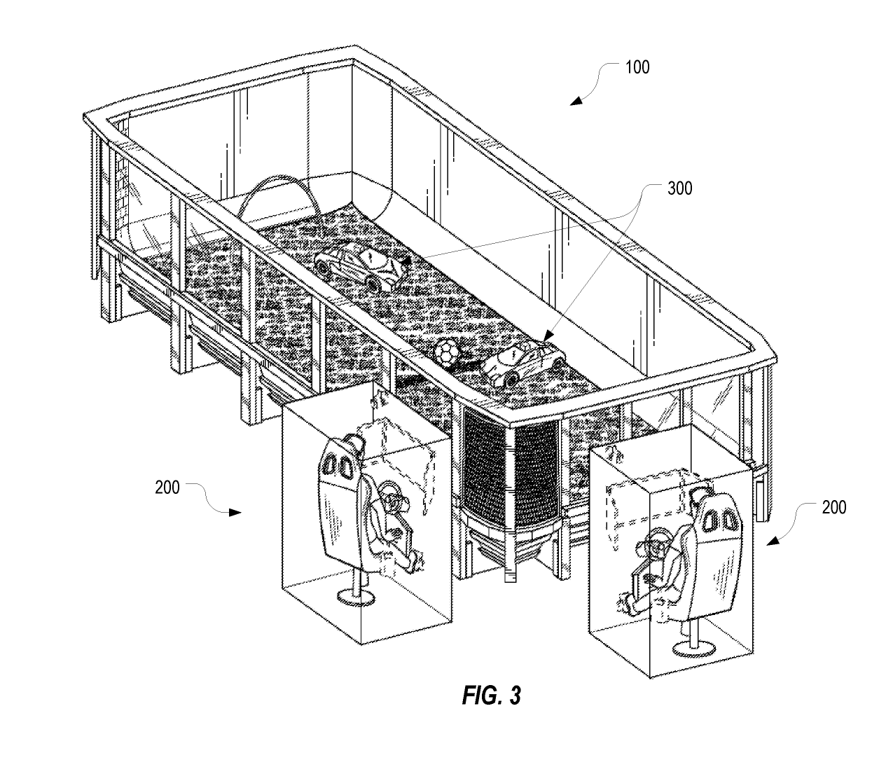

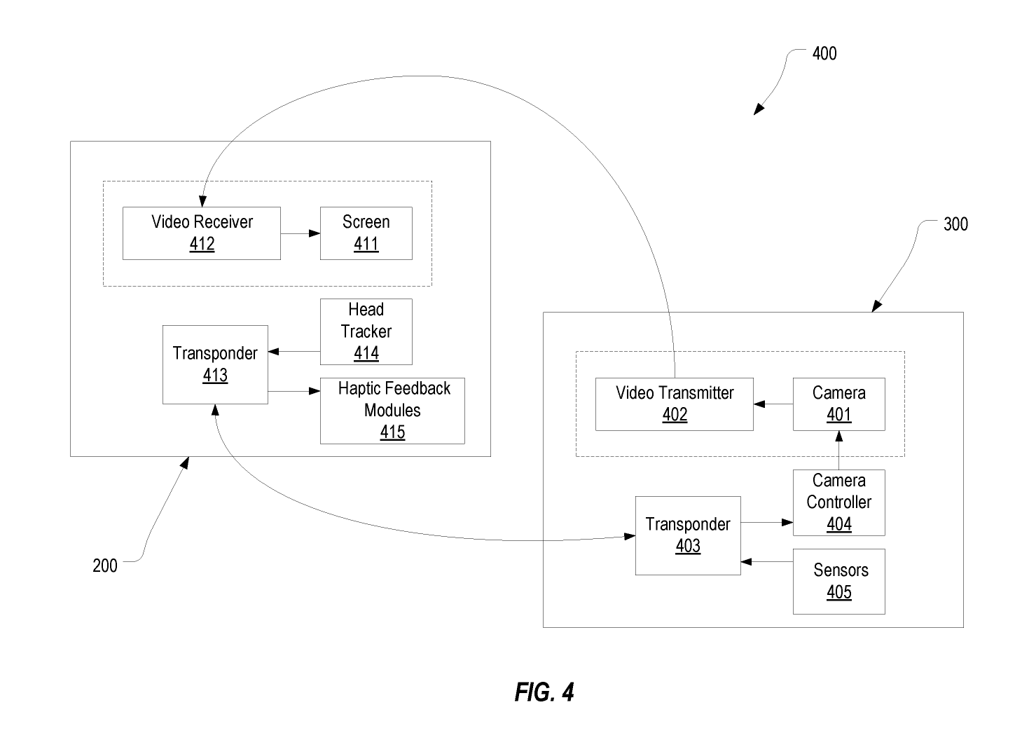

As represented in FIG. 3, cockpits 200 enable users to have a first-person view experience while controlling vehicles 300 in arena 100. For example, in FIG. 3, the users are depicted as controlling vehicles 300 to play soccer. In accordance with embodiments of the present invention, vehicles 300 and cockpits 200 can be configured to enable an enhanced first-person view experience. A system 400 for implementing these enhancements is shown in FIG. 4.

System 400 includes components 401-405 that are installed on each vehicle 300 and components 411-415 that are provided for each cockpit 200. As shown, each vehicle 300 can include a camera 401 that is mounted on the vehicle to provide a first-person view. Camera 401 can be coupled to (or, as represented by the dashed box, integrated with) a video transmitter 402. Video transmitter 402 can receive a video feed from camera 401 and transmit it to a video receiver 412 pertaining to a particular cockpit 200. Video receiver 412 is coupled to screen 411 (which can represent screen 203, a headset worn by a user in cockpit 200 or another type of display within cockpit 200) such that the video captured by camera 401 will be displayed to the user on screen 411. Because camera 401 is mounted to vehicle 300, a first-person view will be provided.

Cockpit 200 can also include a head tracker 414 which is configured to track movement of the user's head while the user controls vehicle 300. For example, head tracker 414 can represent a camera that is mounted in cockpit 200 and aimed at seat 201 so that it may detect which direction a user seated in seat 201 is looking. Alternatively, head tracker 414 can represent a component of a virtual reality headset (e.g., a gyroscope and/or accelerometers of a mobile phone) that the user is wearing. In any case, head tracker 414 can generate a signal indicative of the relative direction in which the user is looking. This signal can be provided to transponder 413 for transmission to a transponder 403 of vehicle 300. Transponder 403 can then relay the signal to camera controller 404 which can be configured to cause the orientation of camera 401 to be adjusted to match the relative direction in which the user is looking. In some embodiments, camera 401 can include a servo and camera controller 404 can control the angular position of the servo based on the signal it receives from head tracker 414. Of course, other techniques for adjusting the orientation of camera 401 could equally be used.

As an example, when the user is looking straight forward within cockpit 200, head tracker 414 can output a corresponding signal which camera controller 404 will process to cause camera 401 to point straight forward relative to the orientation of vehicle 300. Similarly, if the user turns his or her head to the left, head tracker 414 can output a corresponding signal which camera controller 404 will process to cause camera 401 to point to the left relative to the orientation of vehicle 300.

In other embodiments, camera 401 (or multiple cameras) could be configured to output a panoramic view. In such cases, head tracker 414 could instead be employed to select which subarea of the video feed to output to screen 411 based on the detected orientation of the user's head. In particular, screen 411 may be incapable of displaying the full video feed at any given time due to the panoramic nature of the video feed. Head tracker 414 would therefore be tasked with identifying a “cropped” portion of the video feed to output to screen 411 at any given time. For example, if head tracker 414 detects that the user is looking to the left, head tracker 414 may select the left portion of the panoramic video feed to output to screen 411. Using these techniques, camera 401 could be configured to provide a full 360° first-person view and head tracker 414 can ensure that the appropriate portion of the 360° view is displayed at any given time. Of course, if screen 411 were capable of displaying the full panoramic video feed (e.g., a wrap-around screen), head tracker 414 may not need to select which portion of the video feed to display.

System 400 also includes components for providing haptic feedback to further enhance the first-person view experience. As shown, each vehicle 300 can include one or more sensors 405 which can output signals indicative of some force or occurrence. Such signals can be routed by transponder 403 which will transmit the signals to transponder 413 in the corresponding cockpit 200. Transponder 413 can then provide each received signal to the appropriate haptic feedback module 415.

Various types of haptic feedback modules 415 can be provided. For example, a haptic feedback module 415 could be integrated into steering wheel 202 and/or seat 201 and could be configured to vibrate (or provide some other type of motion) when a sensor 405 on vehicle 300 provides a signal indicative of an abrupt force experienced by vehicle 300. Sensor 405 could provide such a signal in response to vehicle 300 contacting another vehicle 300, a wall of arena 100, or another item (e.g., a soccer ball). Similarly, a haptic feedback module 415 could be employed to cause the entire cockpit 200 or a portion of cockpit 200 to shake, tilt, or otherwise move when a corresponding force or motion is detected by a sensor 405 on vehicle 300. As an example, cockpit 200 and/or seat 201 could tilt when vehicle 300 traverses curved wall 111.

Although components 401-405 and components 411-415 are depicted as separate components, the separation is intended to represent the separate nature of their functions, and not necessarily the physical separation of the components. For example, video transmitter 402 and transponder 403 could be the same physical component, while video receiver 412 and transponder 413 could likewise be the same physical component. It is further noted that transponders 403 and 413 could also be employed to perform typical remote control functionality. For example, transponder 413 can be configured to relay signals to transponder 403 which define steering and speed controls for vehicle 300.

Although system 400 has been described in conjunction with arena 100, it may also be employed in other settings to provide an enhanced first-person view experience. For example, cockpits 200 could be provided to control vehicles on an open track or area. In short, system 400 can be employed to control the vehicles in any environment that is within range of the wireless communication techniques.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A remote control arena comprising:
walls defining an enclosed area, at least some of the walls being formed by vertical posts that are interconnected by horizontal supports, curved supports that extend inwardly from each vertical post, vertical walls that are coupled to the vertical posts to form a continuous vertical surface, and curved walls positioned below the vertical walls, the curved walls extending overtop and conforming to the curved supports to form a continuous curved interface between a floor of the arena and the vertical walls.

2. The remote control arena of claim 1, wherein the horizontal supports comprise inner horizontal supports that each extends between an adjacent pair of vertical posts and couples to an inner side of the adjacent pair of vertical posts.

3. The remote control arena of claim 2, wherein the horizontal supports comprise outer horizontal supports that are positioned overtop the inner horizontal supports, each outer horizontal support coupling to an exterior side of two or more vertical posts.

4. The remote control arena of claim 1, wherein the horizontal supports comprise upper horizontal supports that extend between two or more vertical posts and are positioned above and couple to a top end of vertical posts.

5. The remote control arena of claim 1, wherein each curved support includes an inner side that is curved.

6. The remote control arena of claim 5, wherein the curved inner side has a radius of curvature of between one and three feet.

7. The remote control arena of claim 5, wherein the curved inner side has a round or an elliptical curvature.

8. The remote control arena of claim 1, wherein the horizontal supports are positioned overtop an interface between a top edge of the curved walls and a bottom edge of the vertical walls.

9. The remote control arena of claim 1, further comprising:
one or more reinforcing supports that extend between adjacent pairs of curved supports, each reinforcing support having an inner side that aligns with a curved inner side of the corresponding pair of curved supports.

10. The remote control arena of claim 1, further comprising:
a gate formed in one or more of the walls.

11. The remote control arena of claim 1, wherein the vertical walls include transparent walls and opaque walls.

12. The remote control arena of claim 1, further comprising soccer goals at opposing ends of the enclosed area.

13. The remote control arena of claim 1, further comprising:
a plurality of cockpits, each cockpit including a seat in which a user sits while driving a vehicle in the arena.

14. The remote control arena of claim 13, wherein each cockpit includes a screen on which video captured by a camera mounted on the corresponding vehicle is displayed, each cockpit also including a head tracker that tracks a relative orientation of the user's head and outputs a control signal for controlling a relative orientation of the camera.

15. The remote control arena of claim 13, wherein each cockpit includes a receiver for receiving haptic feedback signals from one or more sensors mounted on the corresponding vehicle, each cockpit also including one or more haptic feedback modules that are driven in accordance with the received haptic feedback signals.

16. A remote control arena comprising:
walls defining an enclosed area, at least some of the walls formed by curved walls and vertical walls, the curved walls forming a continuous curved interface between a floor of the arena and the vertical walls; and
a plurality of cockpits, each cockpit including a seat in which a user sits while driving a vehicle in the arena, a screen on which a video feed received from a camera mounted on the corresponding vehicle is displayed, and a head tracker for detecting a relative orientation of the user's head and for generating and sending control signals to control a relative orientation of the camera on the vehicle.

17. The remote control arena of claim 16, wherein each cockpit further includes one or more haptic feedback modules configured to provide haptic feedback within the cockpit in accordance with haptic feedback signals received from one or more sensors installed on the corresponding vehicle.

18. The remote control arena of claim 16, wherein the at least some of the walls are formed by vertical posts that are interconnected by horizontal supports and curved supports that extend inwardly from each vertical post, wherein the vertical walls are coupled to the vertical posts to form a continuous vertical surface, and the curved walls are positioned below the vertical walls and extend overtop and conform to the curved supports to form the continuous curved interface.

19. A remote control environment comprising:
an area;
vehicles that are configured to be controlled within the area, each vehicle including a camera that is mounted to enable the camera's orientation to be adjusted, a video transmitter for transmitting a video feed output from the camera, and a camera controller for controlling the camera's orientation; and
a plurality of cockpits in which users sit while controlling the vehicles, each cockpit including a seat, a screen on which the video feed received from the camera mounted on the corresponding vehicle is displayed, and a head tracker for detecting a relative orientation of the user's head and for generating and sending control signals to the camera controller on the corresponding vehicle;
wherein the camera controller controls the camera's orientation in accordance with the control signals received from the head tracker in the corresponding cockpit such that the orientation of the camera relative to the vehicle corresponds to the orientation of the user's head relative to the corresponding cockpit.

20. The remote control environment of claim 19, wherein the screen and the head tracker are integrated into a headset worn by the user within the cockpit.
